(19) United States
(12) Patent Application Publication
(10) Pub. No.: US 2014/0379479 A1
(43) Pub. Date: Dec. 25, 2014

(54) ADVERTISEMENT PROVISION MANAGEMENT APPARATUS, ADVERTISEMENT PROVISION MANAGEMENT METHOD, AND RECORDING MEDIUM

(71) Applicant: YAHOO JAPAN CORPORATION, Tokyo (JP)

(72) Inventor: Azumi ZENIYA, Tokyo (JP)

(21) Appl. No.: 14/305,377

(22) Filed: Jun. 16, 2014

(30) Foreign Application Priority Data
Jun. 19, 2013 (JP) 2013-128824

(51) Int. Cl. G06Q 30/02

(52) U.S. Cl. CPC G06Q 30/0261; G06Q 30/0267; G06Q 30/0269
USPC 705/14.58

(57) ABSTRACT

There is provided an advertisement provision management apparatus including an information acquisition unit and a content selection unit. The information acquisition unit acquires, from a portable terminal that is present in the vicinity of a digital signage terminal installed at any location, identification information of the portable terminal and use information of the portable terminal. The content selection unit selects content to be displayed on the portable terminal identified by the identification information, on the basis of content-relating information stored while being associated with content displayed on the digital signage terminal and the use information acquired from the portable terminal.

### CROSS-REFERENCE TO RELATED APPLICATIONS

The present invention contains subject matter related to Japanese Patent Application No. 2013-128824 filed in the Japan Patent Office on Jun. 19, 2013, the entire contents of which are incorporated herein by reference.

### BACKGROUND OF THE INVENTION

1. Field of the Invention

The present invention relates to an advertisement provision management apparatus, an advertisement provision management method, and a recording medium.

2. Description of the Related Art

In recent years, digital signage has been widely used. Digital signage is an electronic signage system that displays video or content relating to various types of information on a big-screen video display (digital signage terminal) installed at a location (on a street corner, in a shop, in a station, or the like) where many people's attention is easily attracted. Digital signage has been utilized as an advertisement medium by delivering advertisement content.

In contrast to the case of providing advertisement content to a large number of unspecified viewers (users) like television commercials, in the case of digital signage, a target is set by taking into consideration the location of installation, hours, and the like to thereby allow advertisement content focusing on the target to be displayed on a digital signage terminal.

For example, Japanese Unexamined Patent Application Publication No. 2012-98598 proposes a technique of selecting content to be displayed on a digital signage terminal on the basis of demographic information, such as the sex, age group, or the like, of a viewer carrying a portable terminal around a digital signage terminal. According to this technique, it is possible to provide a viewer with timely information that the viewer may be interested in by displaying content relating to a campaign or the like that fits the sex, age group, or the like of the viewer.

When a viewer is interested in content displayed on a digital signage terminal, the viewer may operate his/her portable terminal and search for a web page or the like from which information relating to the content is acquired. The viewer may try to acquire more detailed information relating to the content after getting home, by operating a personal computer (PC) or the like with which a search is more easily performed.

However, some viewers may stop a search before getting to a final desired page from which information relating to the content is acquired, although they are interested in the content displayed on the digital signage terminal, or may forget to perform a search, although they had intended to perform the search later.

Therefore, providing, to a portable terminal of a viewer who is expected to be interested in content displayed on a digital signage terminal, information relating to the content is an effective way of advertisement.

### SUMMARY OF THE INVENTION

Accordingly, information relating to content displayed on a digital signage terminal is to be provided on a specific portable terminal.

According to an aspect, there is provided an advertisement provision management apparatus including an information acquisition unit and a content selection unit. The information acquisition unit acquires, from a portable terminal that is present in the vicinity of a digital signage terminal installed at any location, identification information of the portable terminal and use information of the portable terminal. The content selection unit selects content to be displayed on the portable terminal identified by the identification information, on the basis of content-relating information stored while being associated with content displayed on the digital signage terminal and the use information acquired from the portable terminal.

According to another aspect, there is provided an advertisement provision management method in which a computer executes a process, the process including acquiring, from a portable terminal that is present in the vicinity of a digital signage terminal installed at any location, identification information of the portable terminal and use information of the portable terminal, and selecting content to be displayed on the portable terminal identified by the identification information, on the basis of content-relating information stored while being associated with content displayed on the digital signage terminal and the use information acquired from the portable terminal.

According to another aspect, there is provided a recording medium storing a program that makes a computer execute a process, the process including acquiring, from a portable terminal that is present in the vicinity of a digital signage terminal installed at any location, identification information of the portable terminal and use information of the portable terminal, and selecting content to be displayed on the portable terminal identified by the identification information, on the basis of content-relating information stored while being associated with content displayed on the digital signage terminal and the use information acquired from the portable terminal.

According to an aspect, it is possible to provide information relating to content displayed on a digital signage terminal to a specific portable terminal.

### BRIEF DESCRIPTION OF THE DRAWINGS

FIG. 1 is a diagram illustrating an example of an overall configuration of an advertisement system according to an embodiment;

FIG. 2 is a diagram illustrating an example of another overall configuration of an advertisement system according to an embodiment;

FIG. 3 is a diagram illustrating an example of a configuration of an advertisement provision management server according to an embodiment;

FIG. 4 is a diagram illustrating an example of a data structure of a signage information database according to an embodiment;

FIG. 5 is a diagram illustrating an example of a data structure of a content-relating information database according to an embodiment;

FIG. 6 is a diagram illustrating an example of a data structure of a content management table according to an embodiment;

FIG. 7 is a sequence chart illustrating an example of provision of an advertisement by an advertisement system according to an embodiment;

FIGS. 8A and 8B are diagrams used for describing an effect of provision of an advertisement according to an embodiment;

FIG. 9 is a flowchart illustrating operations (provision of an advertisement) performed by an advertisement provision management server according to an embodiment;

FIG. 10 is a diagram illustrating an example of another data structure of a content-relating information database according to an embodiment;

FIG. 11 is a diagram illustrating an example of a configuration of an advertisement provision management server according to a modification of an embodiment;

FIG. 12 is a diagram illustrating an example of a data structure of a content-relating information database according to a modification;

FIG. 13 is a diagram illustrating an example of a data structure of a flag management table according to a modification;

FIG. 14 is a flowchart illustrating operations (flag setting) performed by an advertisement provision management server according to a modification;

FIG. 15 is a flowchart illustrating operations (provision of an advertisement) performed by an advertisement provision management server according to a modification; and

FIG. 16 is a diagram illustrating an example of a hardware configuration of an advertisement provision management server according to an embodiment and a modification.

### DETAILED DESCRIPTION OF THE PREFERRED EMBODIMENTS

Embodiments of the present invention will be described below with reference to the attached drawings. Note that, in this specification and the attached drawings, constituent elements having substantially the same functional configuration are given the same numeral and duplicated description thereof will be omitted herein.

Overall Configuration of System

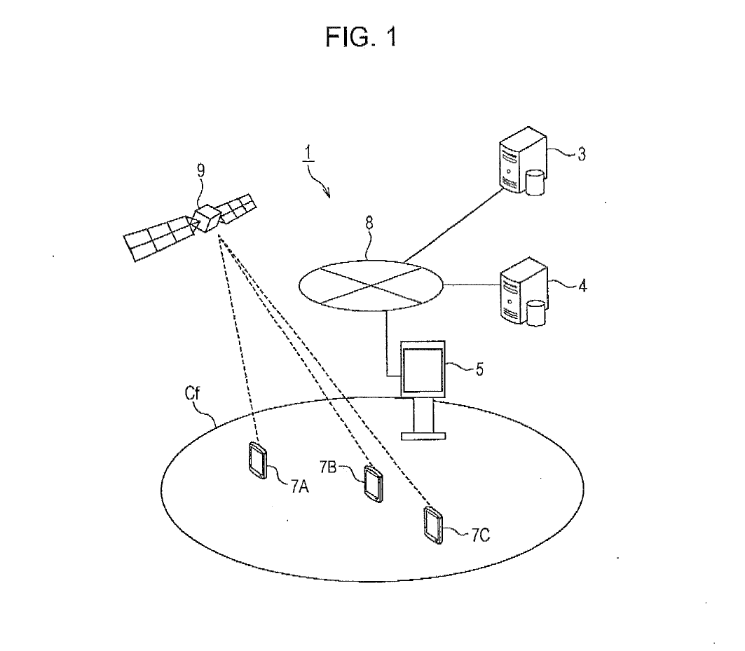

An overall configuration of an advertisement system according to an embodiment of the present invention will be described with reference to FIG. 1. FIG. 1 is a diagram illustrating an overall configuration of an advertisement system 1 according to an embodiment.

The advertisement system 1 includes an advertisement provision management server 3, a content delivery server 4, and a digital signage terminal 5.

The advertisement provision management server 3, the content delivery server 4, and the digital signage terminal 5 are connected to one another over a network 8, which may be a wired or wireless network, such as the Internet. Portable terminals 7A, 7B, 7C, and the like are terminals that are present within an area Cf that meets a predetermined condition based on the position of the digital signage terminal 5. The area Cf that meets a predetermined condition may be an area where viewers carrying the portable terminals 7A, 7B, 7C, and the like are able to view an advertisement displayed on the digital signage terminal 5, or may be an area within a radius of x (x may be any number) meters from the digital signage terminal 5.

It is determined whether or not the portable terminal 7A, 7B, 7C, or the like is present within the area Cf that meets a predetermined condition based on the position of the digital signage terminal 5, on the basis of positional information stored in advance while being associated with the digital signage terminal 5 and positional information on the portable terminal 7A, 7B, 7C, or the like. As the positional information on the portable terminal 7A, 7B, 7C or the like, positional information received from a satellite 9 using a global positioning system (GPS) may be used.

Note that generally a plurality of digital signage terminals 5 are used. The advertisement provision management server 3 and the content delivery server 4 may be implemented using one apparatus or may be implemented using a plurality of apparatuses in a distributed manner.

The advertisement provision management server 3 manages delivery of content to the digital signage terminal 5. The advertisement provision management server 3 also manages delivery of content to the portable terminals 7A, 7B, 7C, and the like. The advertisement provision management server 3 corresponds to an advertisement provision management apparatus that selects content to be displayed on the portable terminal 7A, 7B, 7C, or the like. Content to be delivered includes general content, such as news, weather forecast, fortune-telling, and the like, and specialized content specific to a facility (a commercial facility, a community facility, or the like) where the digital signage terminal 5 is installed, in addition to advertisement content.

The content delivery server 4 is an apparatus that delivers content to the corresponding digital signage terminal 5 and the portable terminal 7A, 7B, 7C, or the like in accordance with an instruction given by the advertisement provision management server 3. Content data is delivered to the content delivery server 4 from an advertiser terminal, which is not illustrated, and is registered in the content delivery server 4. Management information relating to the content data registered in the content delivery server 4 is managed by the advertisement provision management server 3.

The digital signage terminal 5 is an apparatus that has a big-screen video display, displays content, and provides viewers around the digital signage terminal 5 with information relating to the content.

Another Overall Configuration

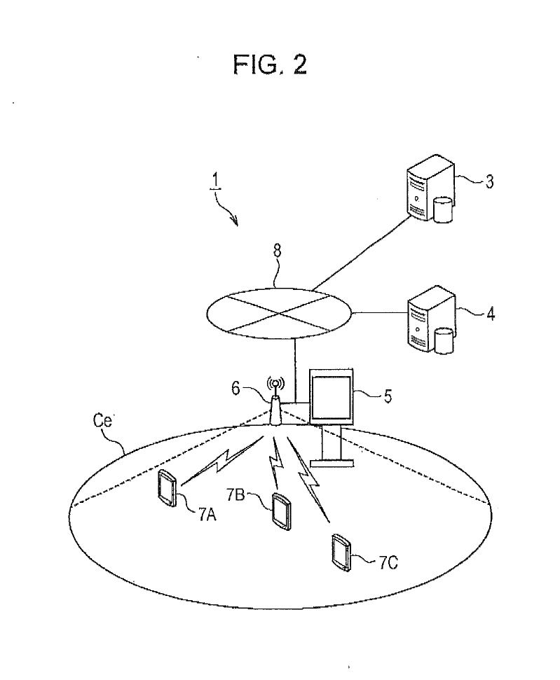

Another overall configuration of the advertisement system 1 according to the embodiment of the present invention will be described with reference to FIG. 2. FIG. 2 is a diagram illustrating another overall configuration of the advertisement system 1 according to the embodiment.

In another configuration of the advertisement system 1 according to the embodiment, the advertisement system 1 includes the advertisement provision management server 3, the content delivery server 4, the digital signage terminal 5, and a radio base station 6.

The advertisement provision management server 3, the content delivery server 4, the digital signage terminal 5, and the radio base station 6 are connected to one another over the network 8, which may be a wired or wireless network, such as the Internet. The digital signage terminal 5 is installed within a communication-enabled area Ce of the radio base station 6. The radio base station 6 is able to connect with the portable terminals 7A, 7B, 7C, and the like that are present within the communication-enabled area Ce.

Note that generally a plurality of digital signage terminals 5 and a plurality of radio base stations 6 are used. The advertisement provision management server 3 and the content delivery server 4 may be implemented using one apparatus or may be implemented using a plurality of apparatuses in a distributed manner.

The advertisement provision management server 3, the content delivery server 4, and the digital signage terminal 5 have been described above and therefore description thereof will be omitted here.

The radio base station 6 may be an access point in a wireless local area network (LAN) typically based on wireless fidelity (Wi-Fi) communication or the like. The radio base station 6 is installed in the vicinity of the digital signage terminal 5. When the radio base station 6 detects the portable terminals 7A, 7B, 7C, and the like that are present in the vicinity of the radio base station 6, the radio base station 6 transmits identification information of the detected portable terminals, the radio base station identifier (ID) of the radio base station 6, and use information of the portable terminals to the advertisement provision management server 3. The portable terminals 7A, 7B, 7C, and the like are apparatuses, such as portable phones or smartphones, which viewers carry. Use information of a portable terminal will be described below.

Functional Configuration of Advertisement Provision Management Server

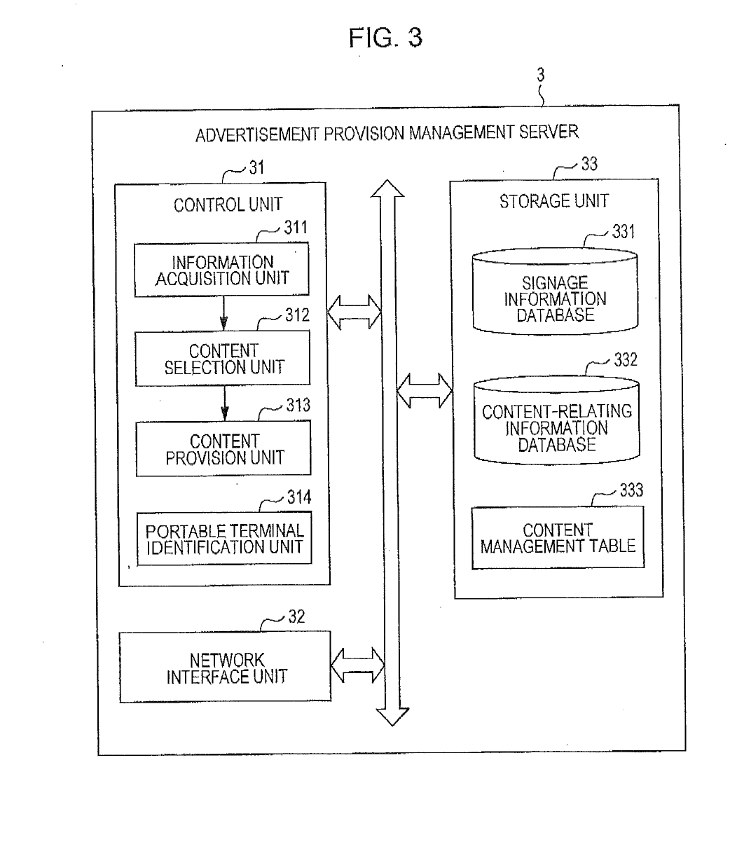

Next, a functional configuration of the advertisement provision management server 3 according to the embodiment will be described with reference to FIG. 3. FIG. 3 is a diagram illustrating an example of a configuration of the advertisement provision management server 3 according to the embodiment.

The advertisement provision management server 3 includes a control unit 31, a network interface unit 32, a storage unit 33, and a portable terminal identification unit 314.

The control unit 31 performs control processing in the advertisement provision management server 3 using a computer program. The network interface unit 32 performs data communication with other apparatuses over the external network 8. The storage unit 33 stores various types of information (data).

The control unit 31 includes an information acquisition unit 311, a content selection unit 312, and a content provision unit 313.

The information acquisition unit 311 acquires from the radio base station 6 via the network 8 identification information of the portable terminals 7A, 7B, 7C, and the like that are present within the communication-enabled are Ce of the radio base station 6 and the radio base station ID of the radio base station 6. The information acquisition unit 311 acquires use information of the portable terminals 7A, 7B, 7C, and the like. The information acquisition unit 311 may acquire information about the installation location of the digital signage terminal 5.

Here, use information of a portable terminal includes information relating to operations, such as input or selection, performed by a viewer operating the portable terminal that is present in the vicinity of any digital signage terminal 5. Examples of use information of the portable terminal 7A, 7B, 7C, or the like include information relating to operations, such as input to the portable terminal 7A, 7B, 7C, or the like at the time of activating an application in the portable terminal 7A, 7B, 7C, or the like or selection of a piece of information from among pieces of information displayed on the screen of the portable terminal 7A, 7B, 7C, or the like. Examples of information relating to operations, such as input or selection, include a search keyword, a uniform resource locator (URL), and a word or a term inputted or selected in order to activate an application.

The content selection unit 312 selects content to be delivered to the portable terminal 7A, 7B, 7C, or the like on the basis of content-relating information that indicates information relating to content displayed on the digital signage terminal 5 and use information acquired from the portable terminal 7A, 7B, 7C, or the like.

The content provision unit 313 instructs the content delivery server 4 to deliver the content selected by the content selection unit 312. The content provision unit 313 instructs the content delivery server 4 to deliver the selected content to the portable terminal 7A, 7B, 7C, or the like that is identified by the identification information.

The portable terminal identification unit 314 identifies a portable terminal that is present in the vicinity of the digital signage terminal 5.

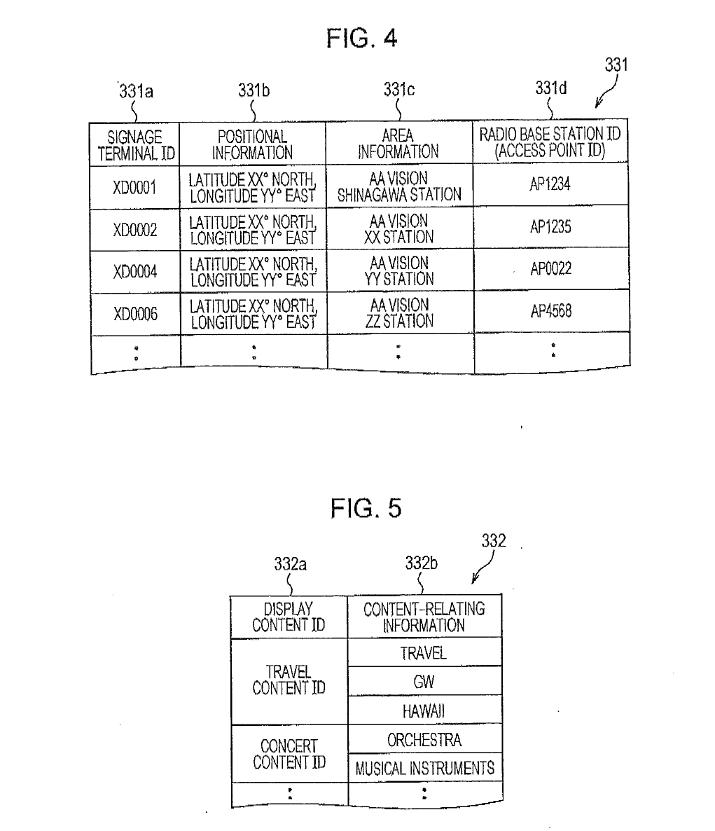

In the case of the overall configuration illustrated in FIG. 1, the portable terminal identification unit 314 determines whether or not the portable terminal 7A, 7B, 7C, or the like is present within the area Cf that meets a predetermined condition based on the position of the digital signage terminal 5, on the basis of positional information (for example, positional information 331b in FIG. 4) stored in advance while being associated with the digital signage terminal 5 and positional information on the portable terminal 7A, 7B, 7C, or the like acquired using a GPS. The information acquisition unit 311 acquires identification information of the portable terminal 7A, 7B, 7C, or the like that has been determined to be present within the area Cf that meets a predetermined condition based on the position of the digital signage terminal 5, together with use information of the determined portable terminal.

In the case of the other overall configuration illustrated in FIG. 2, the portable terminal identification unit 314 determines whether or not the radio base station 6 the ID of which (for example, a radio base station ID 331d in FIG. 4) has been stored in advance while being associated with the digital signage terminal 5 is in a state where communication with the portable terminal 7A, 7B, 7C, or the like is possible. The information acquisition unit 311 acquires identification information of the portable terminal 7A, 7B, 7C, or the like that has been determined to be in a state where communication with the radio base station 6 is possible together with use information of the determined portable terminal.

Here, the portable terminal identification unit 314 is able to determine that the portable terminal 7A, 7B, 7C, or the like is in a state where communication with the radio base station 6 is possible if the radio field intensity of radio signals that the portable terminal 7A, 7B, 7C, or the like receives from the radio base station 6 is equal to or higher than a predetermined threshold. Alternatively, the portable terminal identification unit 314 may determine that the portable terminal 7A, 7B, 7C, or the like is in a state where communication with the radio base station 6 is possible on the basis of the fact that a state where the radio field intensity is equal to or higher than a predetermined threshold continues for a predetermined period of time.

The storage unit 33 includes a signage information database 331, a content-relating information database 332, and a content management table 333. The signage information database 331 is a database that stores management information about the digital signage terminal 5. The content-relating information database 332 is a database that stores content-relating information while associating the content-relating information with the corresponding content. The content management table 333 is a database that stores schedule information on content to be displayed on the digital signage terminal 5.

FIG. 4 is a diagram illustrating an example of a data structure of the signage information database 331 according to the embodiment. In FIG. 4, the signage information database 331 includes items (fields), namely, a signage terminal ID 331a, the positional information 331b, area information 331c, and the radio base station ID (access point ID) 331d.

The signage terminal ID 331a is information used to identify the digital signage terminal 5. The positional information 331b is information about the latitude and longitude of a location where the digital signage terminal 5 is installed. The area information 331c indicates the name of a region corresponding to the positional information 331b. The radio base station ID (access point ID) 331d is information used to identify the radio base station 6 installed in the vicinity of the digital signage terminal 5.

FIG. 5 is a diagram illustrating an example of a data structure of the content-relating information database 332 according to the embodiment. In FIG. 5, the content-relating information database 332 includes items (fields), namely, a display content ID 332a and content-relating information 332b.

The display content ID 332a is identification information of content to be displayed on the digital signage terminal 5. Content identified by the display content ID 332a is provided from an advertiser terminal, which is not illustrated. The content-relating information 332b is information relating to content, and is provided together with the content from an advertiser terminal that has provided the content, which is identified by the display content ID 332a.

Examples of the content-relating information 332b includes, in the case where advertisement content is displayed on the digital signage terminal 5, a keyword, a URL, or the like that a viewer who is interested in the advertisement is expected to input or select when operating his/her portable terminal. The content-relating information 332b may include one piece of information or a plurality of pieces of information.

For example, in the case where an advertiser terminal provides travel content relating to an advertisement for travels during Golden Week (which may be abbreviated as GW), the advertiser terminal transmits related keywords, such as “travel”, “overseas”, “Hawaii”, “GW”, and the like together with the travel content. The storage unit 33 associates such related keywords with the display content ID 332a of the travel content and stores the related keywords as the content-relating information 332b.

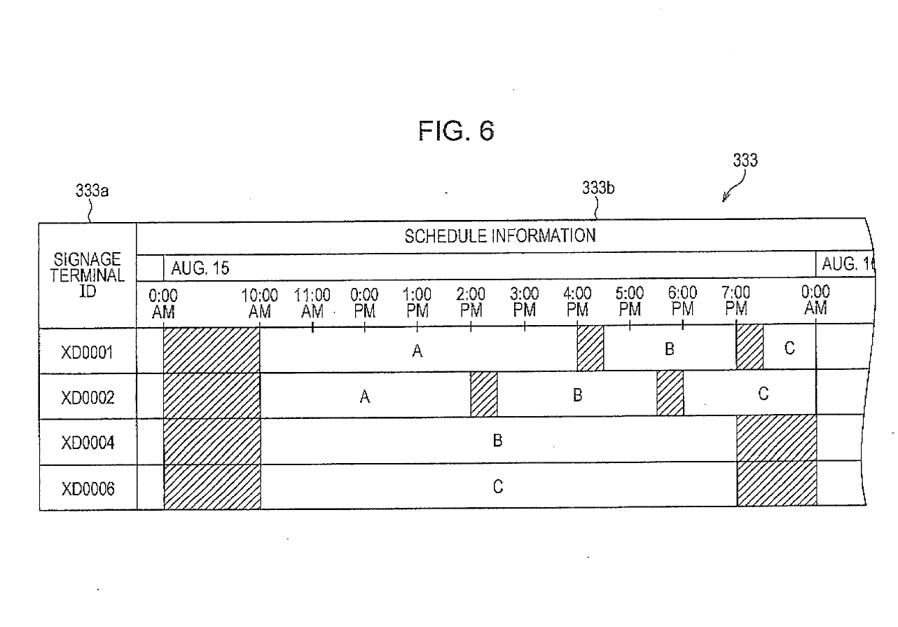

FIG. 6 is a diagram illustrating an example of a data structure of the content management table 333 according to the embodiment. In FIG. 6, the content management table 333 is a table that stores schedule information 333b indicating content to be displayed on each digital signage terminal identified by a signage terminal ID 333a and the display hours of the content.

Example of Provision of Advertisement by Advertisement System

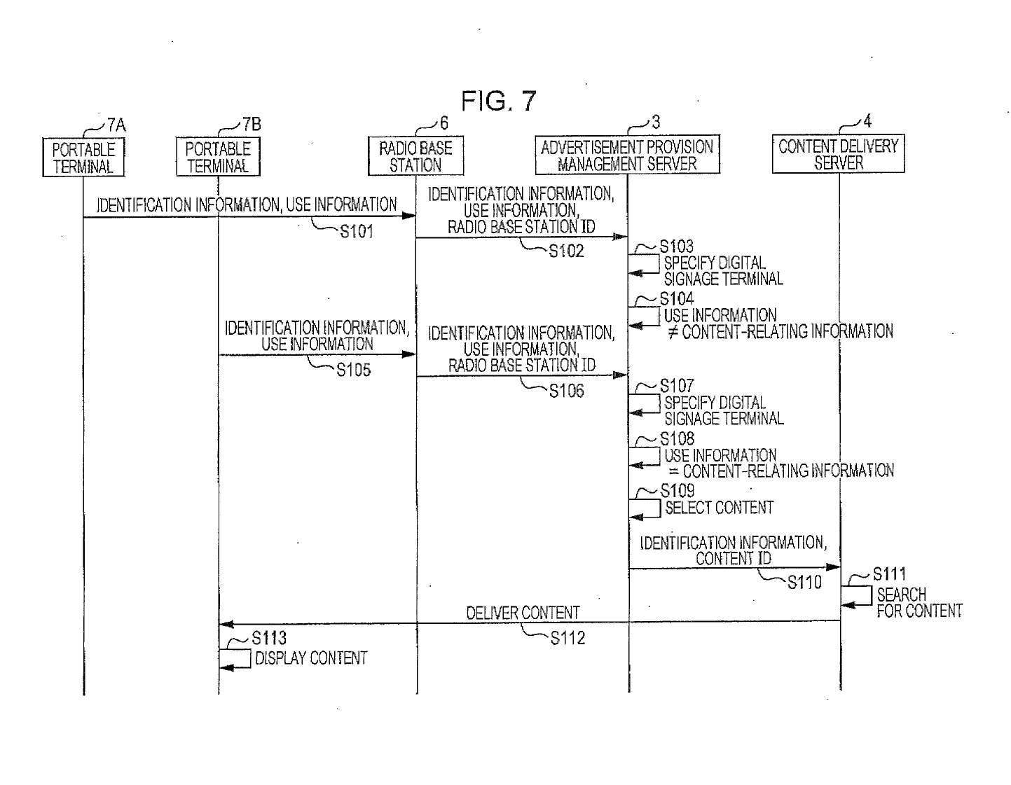

Next, an example of provision of an advertisement by the advertisement system 1 according to the embodiment will be described with reference to FIG. 7. FIG. 7 is a sequence chart illustrating an example of provision of an advertisement by the advertisement system 1 according to the embodiment. Hereinafter, description will be given of a case where the advertisement provision management server 3 acquires identification information of the portable terminals 7A, 7B, 7C, and the like that have been determined to be in a state where communication with the radio base station 6 is possible as illustrated in FIG. 2, together with use information of the portable terminals. However, the advertisement provision management server 3 may acquire identification information of the portable terminals 7A, 7B, 7C, and the like that have been determined to be within the area Cf that meets a predetermined condition based on the position of the digital signage terminal 5, on the basis of positional information stored in advance while being associated with the digital signage terminal 5 and positional information on the portable terminals 7A, 7B, 7C, and the like as illustrated in FIG. 1, together with use information of the portable terminals. In this case, the radio base station 6 that acts as an intermediary between the advertisement provision management server 3 and the portable terminals 7A, 7B, 7C, and the like as illustrated in FIG. 7 does not exist, and identification information and use information of the portable terminals 7A, 7B, 7C, and the like are directly received by the advertisement provision management server 3.

In FIG. 7, when the portable terminal 7A has come into the communication-enabled area Ce in the vicinity of the radio base station 6, the portable terminal 7A transmits identification information of the portable terminal 7A and use information of the portable terminal 7A to the radio base station 6 in the process of Wi-Fi connection, mobile wireless connection, or the like (step S101).

Note that the radio base station 6 is able to acquire identification information of the portable terminal 7A, 7B, 7C, or the like that has come into the communication-enabled area Ce by means of short-range wireless communication based on near field communication (NFC), Bluetooth (registered trademark), or the like or by using a check-in function or the like of an application installed in the portable terminal 7A, 7B, 7C, or the like. As identification information of a portable terminal, the user ID, the media access control (MAC) address, cookie information, or the like may be used. The radio base station 6 is able to acquire positional information on the portable terminals 7A, 7B, 7C, and the like using a GPS or the like.

When the radio base station 6 has received the identification information and use information from the portable terminal 7A in step S101, the radio base station 6 transmits the identification information, the use information, and the radio base station ID thereof to the advertisement provision management server 3 (step S102).

Similarly, when the portable terminal 7B has come into the communication-enabled area Ce in the vicinity of the radio base station 6, the portable terminal 7B transmits identification information of the portable terminal 7B and use information of the portable terminal 7B to the radio base station 6 in the process of Wi-Fi connection, mobile wireless connection, or the like (step S105).

When the radio base station 6 has received the identification information and use information from the portable terminal 7B in step S105, the radio base station 6 transmits the identification information, the use information, and the radio base station ID thereof to the advertisement provision management server 3 (step S106).

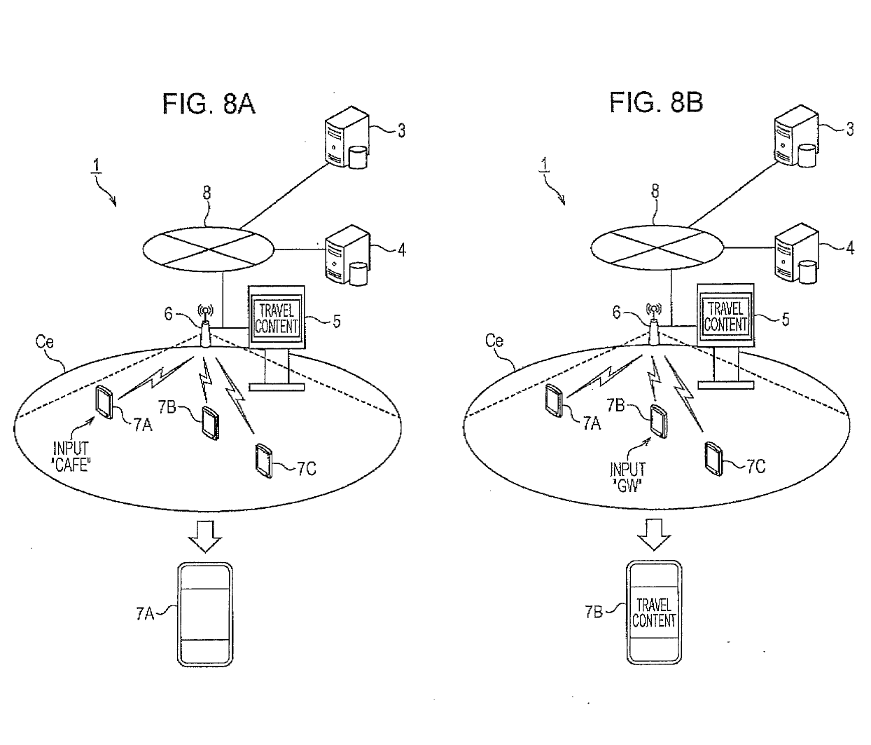

For example, FIGS. 8A and 8B illustrate cases where content relating to travels during Golden Week is displayed on the digital signage terminal 5. As illustrated in FIG. 8A, when a viewer operates the portable terminal 7A located in the vicinity of the digital signage terminal 5 and inputs a word “cafe”, the radio base station 6 transmits use information of the portable terminal 7A, which is the word “cafe”, identification information of the portable terminal 7A, and the radio base station ID of the radio base station 6 to the advertisement provision management server 3.

Similarly, when a viewer operates the portable terminal 7B located in the vicinity of the digital signage terminal 5 and inputs a word “GW” as illustrated in FIG. 8B, the radio base station 6 transmits use information of the portable terminal 7B, which is the word “GW”, identification information of the portable terminal 7B, and the radio base station ID of the radio base station 6 to the advertisement provision management server 3.

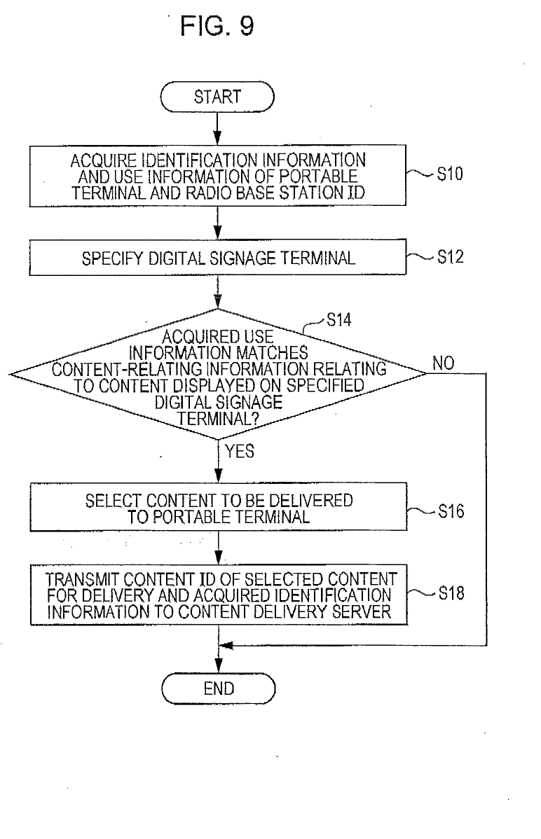

Steps S103, S104, and S107 to S110, which correspond to operations performed by the advertisement provision management server 3, will be described while also referring to a flowchart illustrated in FIG. 9, which illustrates operations (provision of an advertisement) performed by the advertisement provision management server 3 according to the embodiment.

As a result of processing performed in step S102 in FIG. 7, the information acquisition unit 311 acquires the identification information, the use information, and the radio base station ID in step S10 in FIG. 9. Next, in step S12 in FIG. 9, the content selection unit 312 searches the signage information database 331 and selects the radio base station ID (access point ID) 331d that matches the acquired radio base station ID. The content selection unit 312 selects the signage terminal ID 331a stored while being associated with the selected radio base station ID 331d. As a result, a digital signage terminal that is identified by the selected signage terminal ID 331a is specified.

For example, the digital signage terminal 5 specified in steps S103 and S107 in FIG. 7 is installed within the communication-enabled area Ce of the radio base station 6 and is a terminal that is located in the vicinity of the portable terminals 7A and 7B.

Note that the digital signage terminal 5 may be specified by performing matching processing between positional information on the portable terminals 7A and 7B which is able to be acquired using a GPS or the like and the positional information 331b (FIG. 4) on each digital signage terminal.

Next, in step S14 in FIG. 9, the content selection unit 312 determines whether or not the acquired use information matches the content-relating information 332b stored while being associated with content displayed on the specified digital signage terminal. In the content-relating information database 332 illustrated in FIG. 5, the content-relating information 332b is stored while being associated with the display content ID 332a. Accordingly, the content selection unit 312 searches the content-relating information database 332, and determines whether or not the use information matches the content-relating information 332b stored while being associated with the display content ID 332a of content displayed on the digital signage terminal.

In step S14 in FIG. 9, if it is determined that the acquired use information does not match the content-relating information 332b (in the case of step S104 in FIG. 7), the advertisement provision management server 3 ends the processing. For example, in FIG. 8A, the use information of the portable terminal A, which is “cafe”, does not match any of “travel”, “GW”, and “Hawaii”, which are included in the content-relating information 332b corresponding to the display content ID 332a in FIG. 5 which corresponds to travel content being displayed on the digital signage terminal 5. Therefore, the advertisement provision management server 3 ends the processing without performing anything else. As a result, the portable terminal 7A does not become a target of recapture (a subject of retargeting (registered trademark)) and therefore data relating to travel content is not delivered to the portable terminal 7A. Accordingly, information relating to “travel content” is not displayed on the screen of the portable terminal 7A illustrated in FIG. 8A.

On the other hand, if it is determined that the acquired use information matches the content-relating information 332b in step S14 in FIG. 9 (in the case of step S108 in FIG. 7), the flow proceeds to step S16, and the content selection unit 312 selects content identified by the display content ID 332a corresponding to the content being displayed, as content for delivery.

For example, if the acquired use information matches the content-relating information 332b in step S108 in FIG. 7, content identified in step S109 in FIG. 7 by the display content ID 332a corresponding to the content being displayed becomes content to be delivered to the portable terminal 7B.

A specific example will be given and described. As illustrated in FIG. 8B, the use information of the portable terminal 7B, which is “GW”, matches one of “travel”, “GW”, and “Hawaii” included in the content-relating information 332b relating to travel content being displayed on the digital signage terminal 5. In this case, it is supposed that a viewer carrying the portable terminal 7B viewed the travel content displayed on the digital signage terminal 5, inputted a word “GW” by operating the portable terminal 7B because the viewer was interested in the content, and tried to acquire further information about the travel content. Therefore, in the embodiment, the portable terminal 7B is determined to be a target of recapture to which advertisement content relating to the travel content is to be delivered. In this case, content identified by the display content ID 332a, which is “travel content ID”, is selected as content to be delivered to the portable terminal 7B.

Next, in step S18 in FIG. 9, the content provision unit 313 transmits the content ID of the selected content for delivery and the identification information of the portable terminal concerned acquired from the radio base station 6 to the content delivery server 4, and the processing ends.

For example, when the advertisement provision management server 3 transmits the display content ID of the selected content and the identification information of the portable terminal 7B to the content delivery server 4 in step S110 in FIG. 7, the content delivery server 4 searches for content identified by the acquired content ID in step S111 in FIG. 7. For example, the content delivery server 4 may search for a piece of content specified by the acquired content ID from among pieces of content in a browser which are linked with the user ID of the portable terminal concerned, and use the piece of content as content to be delivered to the portable terminal. Alternatively, the content delivery server 4 may search for a piece of content specified by the acquired content ID from among pieces of content stored in the content delivery server 4 and use the piece of content as content to be delivered to the portable terminal.

Next, in step S112 in FIG. 7, the content delivery server 4 delivers the resulting content to the portable terminal identified by the acquired identification information. In this case, the resulting content is delivered to the portable terminal 7B.

The portable terminal 7B displays the delivered content on the screen in step S113 in FIG. 7. In the case of FIG. 8B, “travel content” is automatically delivered to the portable terminal 7B that has been determined to be a target of recapture. As a result, information relating to “travel content” is displayed on the screen of the portable terminal 7B.

According to the embodiment, the advertisement provision management server 3 performs matching between the content-relating information 332b stored while being associated with the display content ID 332a and use information of a portable terminal. If the content-relating information 332b matches use information of a portable terminal as a result of matching, it is supposed that a viewer carrying the portable terminal is present in the vicinity of a specific digital signage terminal, is interested in content (which is identifiable by the display content ID 332a) displayed on the digital signage terminal, and is a highly prospective buyer.

Then, the advertisement provision management server 3 assumes the portable terminal as a target of recapture and performs control so as to deliver information relating to the content displayed on the digital signage terminal to the portable terminal. As a result, it is possible to automatically deliver, to a viewer expected to be interested in advertisement content displayed on a digital signage terminal, information relating to the advertisement content. Accordingly, the viewer is able to acquire, in a timely manner, information relating to the advertisement content that the viewer may be interested in. As a result, the viewer does not need to perform troublesome terminal operations in order to get to the final desired page from which detailed information relating to the advertisement content is acquired, or does not miss an opportunity to acquire detailed information relating to the advertisement that the viewer is interested in because the viewer forgot to perform a search, although the viewer had intended to perform the search later.

Note that content to be delivered to a portable terminal of a viewer which has been determined to be a target of recapture as described above may be content itself displayed on the digital signage terminal, or may be other content relating to the content displayed on the digital signage terminal.

For example, if use information of a portable terminal matches “Hawaii”, which is the content-relating information 332b illustrated in FIG. 5, travel content itself that is identified by the display content ID 332a, which is “travel content ID”, the travel content being displayed on the digital signage terminal 5, may be delivered to the portable terminal that has been determined to be a target of recapture.

Alternatively, content to be delivered to a portable terminal that has been determined to be a target of recapture may be determined on the basis of the schedule information 333b set for each digital signage terminal identified by the signage terminal ID 333a as illustrated in the content management table 333 in FIG. 6, for example. In this case, content displayed on a specific digital signage terminal is determined on the basis of the transmission date and time when use information or the like was transmitted from the radio base station 6. For example, if the transmission date and time when use information or the like was transmitted from the radio base station 6 is 1:00 p.m. on August 15, it is possible to determine that content displayed on the digital signage terminal identified by the signage terminal ID 333a, which is “XD0001”, is content “A”. Therefore, in this case, content to be delivered to a portable terminal that has been determined to be a target of recapture is content “A”.

On the other hand, if the transmission date and time when use information or the like was transmitted from the radio base station 6 is 6:00 p.m. on August 15, it is possible to determine that content displayed on the digital signage terminal identified by the signage terminal ID 333a, which is “XD0001”, is content “B”. Therefore, in this case, content to be delivered to a portable terminal that has been determined to be a target of recapture is content “B”.

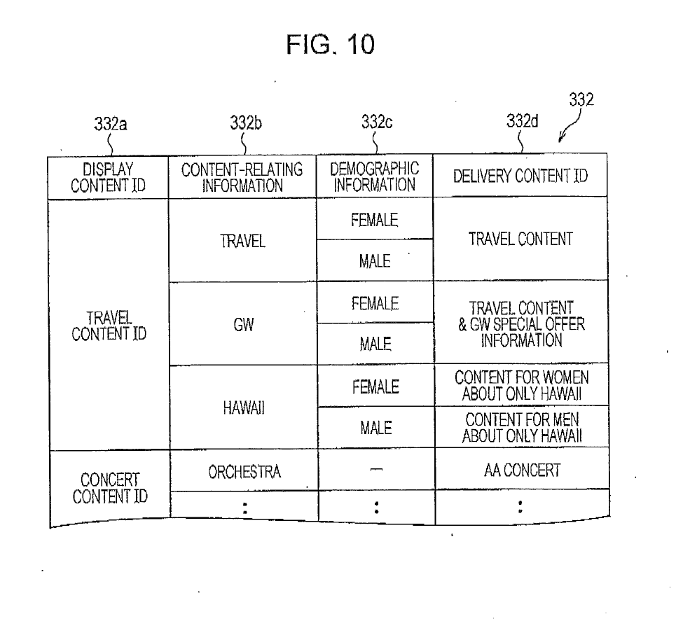

Furthermore, content determined by using the content-relating information database 332 illustrated in FIG. 10 and by taking into consideration demographic information may be delivered to a portable terminal that has been determined to be a target of recapture, for example. In the content-relating information database 332 in FIG. 10, items, namely, demographic information 332c and a delivery content ID 332d are stored in addition to the display content ID 332a and the content-relating information 332b.

The demographic information 332c is attribute information of a viewer carrying a portable terminal. In the content-relating information database 332 in FIG. 10, only sex is indicated as the demographic information 332c, however, the age group, resident area, income, occupation, educational record, family members, and the like of a viewer may be included, for example, in addition to sex, as attribute information of the viewer.

For example, if use information of the portable terminal 7B matches the content-relating information 332b, which is “Hawaii”, in FIG. 10, travel content about only Hawaii which is indicated by the delivery content ID 332d is delivered to the portable terminal 7B that has been determined to be a target for recapture, from among pieces of travel content identified by the display content ID 332a, which is “travel content ID”, the pieces of travel content being displayed on the digital signage terminal 5. In this case, if the demographic information 332c indicates “female”, content for women about only Hawaii is delivered. If the demographic information 332c indicates ‘male’, content for men about only Hawaii is delivered. In this way, it is possible to more effectively deliver detailed information or additional information relating to advertisement content displayed on a digital signage terminal, in accordance with the sex, age group, or the like of the viewer.

Note that selected content may be delivered to a specific portable terminal at any of the timings described in the cases 1 to 5 below by taking into consideration the behavioral characteristic of a viewer carrying a portable terminal. However, content may be delivered at any other timings.

1. Information about hours during which a viewer is walking, sitting, on a train, resting, or hanging around is acquired by using an acceleration sensor mounted in the portable terminal of the viewer. It is assumed that such hours are the viewer's spare time and are hours during which the viewer is able to readily view content, and therefore content is to be delivered to the viewer during such hours.

2. In the case where the continuous operation time of a browser or an application of a portable terminal of a viewer is equal to or longer than a predetermined threshold (minutes) during certain hours, it is assumed that the viewer is able to readily view content during such hours and therefore content is to be delivered to the viewer during such hours.

3. In the case where, in the vicinity of a location where a portable terminal was present when a viewer carrying the portable terminal performed a search relating to content displayed on a certain digital signage terminal 5 and the radio base station 6 acquired use information of the portable terminal relating to the search, the same portable terminal is present, content is to be delivered to the portable terminal at the timing when the portable terminal is present in the vicinity of the location.

4. In the case where a viewer performed a search relating to content displayed on a certain digital signage terminal 5 and the radio base station 6 acquired use information of the portable terminal relating to the search, during certain hours, content is to be delivered during such hours.

5. Content is to be delivered to a portable terminal at a timing when a viewer is detected who is using the portable terminal and is viewing a content page related to use information of the portable terminal.

Configuration According to Modification

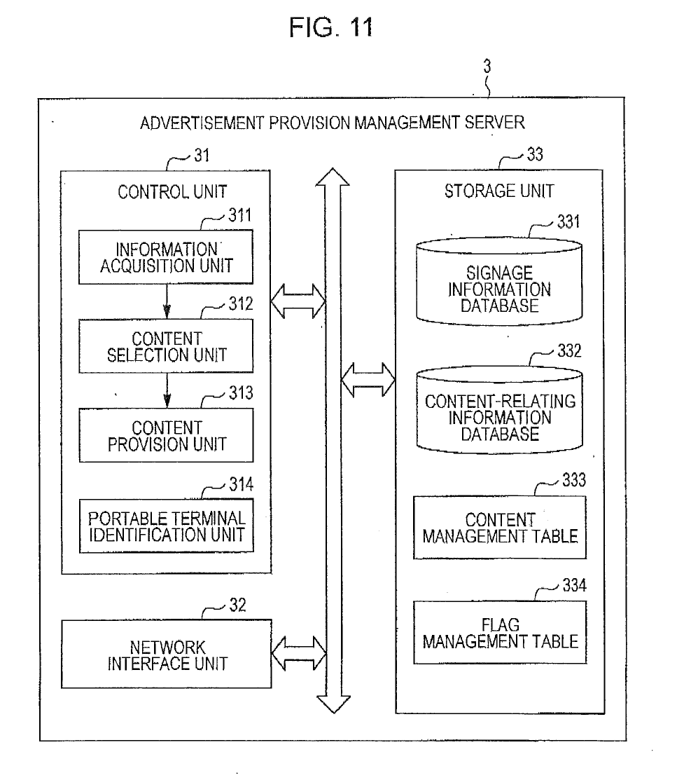

Next, the advertisement provision management server 3 according to a modification of the embodiment will be described with reference to FIGS. 11 to 15. FIG. 11 is a diagram illustrating an example of a configuration of the advertisement provision management server 3 according to a modification.

The advertisement provision management server 3 according to the modification includes a flag management table 334 in addition to the configuration of the advertisement provision management server 3 according to the above-mentioned embodiment illustrated in FIG. 3. Therefore, functions and operations of the advertisement provision management server 3 using the flag management table 334 will be focused on and described below and description that may overlap the description given in the embodiment described above will be omitted.

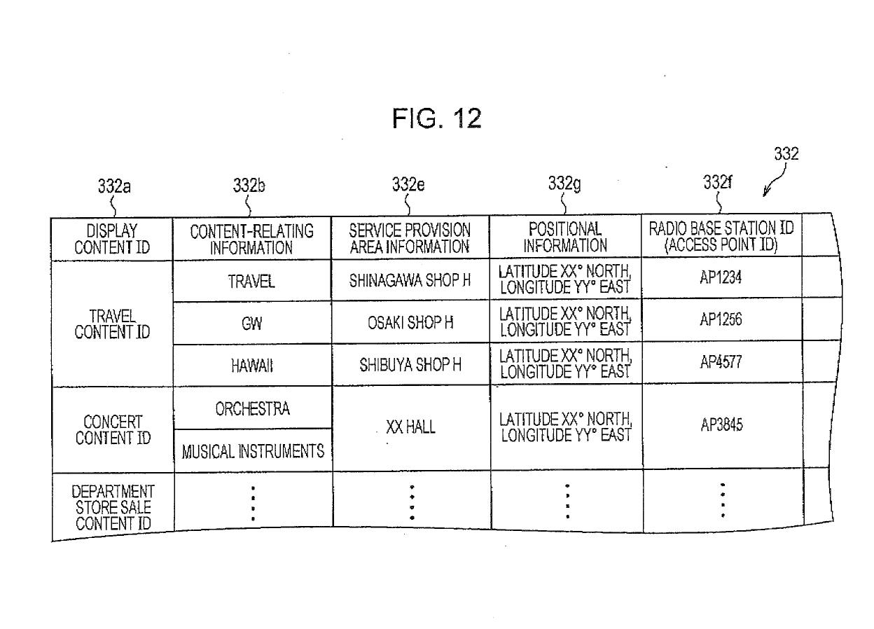

FIG. 12 illustrates an example of a data structure of the content-relating information database 332 according to the modification. The content-relating information database 332 according to the modification stores items, namely, service provision area information 332e, a radio base station ID (access point ID) 332f, and positional information 332g, in addition to the display content ID 332a and the content-relating information 332b.

The service provision area information 332e indicates an area where a service relating to content identified by the display content ID 332a is provided. The positional information 332g indicates the position of a service provision area indicated by the service provision area information 332e. The radio base station ID (access point ID) 332f indicates the radio base station ID of a radio base station installed in an area specified by the service provision area information 332e or in the vicinity of the area. When a radio base station specified by a radio base station ID detects the portable terminal 7A, 7B, 7C, or the like that is present in the vicinity thereof, the radio base station transmits the result of detection to the advertisement provision management server 3.

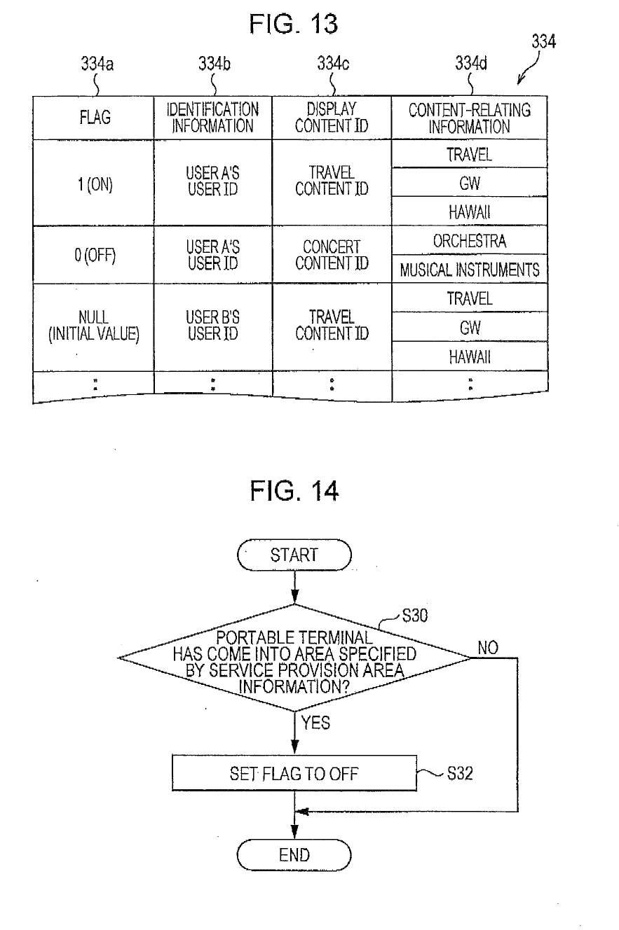

FIG. 13 illustrates an example of a data structure of the flag management table 334 according to the modification. The flag management table 334 according to the modification includes items, namely, a flag 334a, identification information 334b, a display content ID 334c, and content-relating information 334d.

The flag 334a is a flag indicating whether or not a viewer carrying a portable terminal has received, in accordance with content delivered to the portable terminal that is a target of recapture, a service relating to the delivered content. The initial value of the flag 334a is null. The flag 334a is set to 1 (on) when specific content has been delivered to a portable terminal that is a target of recapture. The flag 334a is set to 0 (off) when a viewer carrying a portable terminal that is a target of recapture has received a service relating to the delivered content. Accordingly, the flag 334a being set to 0 (off) indicates that the corresponding portable terminal is not a target of recapture.

The identification information 334b is identification information of a viewer carrying a portable terminal or identification information of a portable terminal. The identification information 334b may be the user ID of a viewer or may be the ID (for example, the MAC address or cookie information) of a portable terminal that the viewer carries.

The display content ID 334c is the ID of content delivered to a portable terminal of a viewer identified by the identification information 334b.

The content-relating information 334d is information relating to content specified by the display content ID 334c.

Note that the portable terminal identification unit 314 identifies a portable terminal that is present in a service provision area indicated by the service provision area information 332e.

In one example, the portable terminal identification unit 314 determines whether or not the portable terminal 7A, 7B, 7C, or the like is present in a service provision area on the basis of positional information (for example, the positional information 332g in FIG. 12) that is stored in advance while being associated with the service provision area information 332e and positional information on the portable terminal 7A, 7B, 7C, or the like acquired using a GPS. The content provision unit 313 sets the flag 334a to 0 (off), the flag 334a corresponding to content (which is identifiable by the display content ID 334c) provided in a service provision area where the portable terminal 7A, 7B, 7C, or the like has been determined to be present.

In another example, the portable terminal identification unit 314 determines whether or not the radio base station 6 the ID of which (for example, the radio base station ID 332f in FIG. 12) has been stored in advance while being associated with the service provision area information 332e is in a state where communication with the portable terminal 7A, 7B, 7C, or the like is possible. The content provision unit 313 sets the flag 334a to 0 (off), the flag 334a corresponding to content (which is identifiable by the display content ID 334c) provided in a service provision area where the portable terminal 7A, 7B, 7C, or the like that has been determined to be in a state where communication with the radio base station 6 is possible is present. Hereinafter, operations performed by the advertisement provision management server 3 according to the modification will be described on the basis of the other example described above.

Operations According to Modification

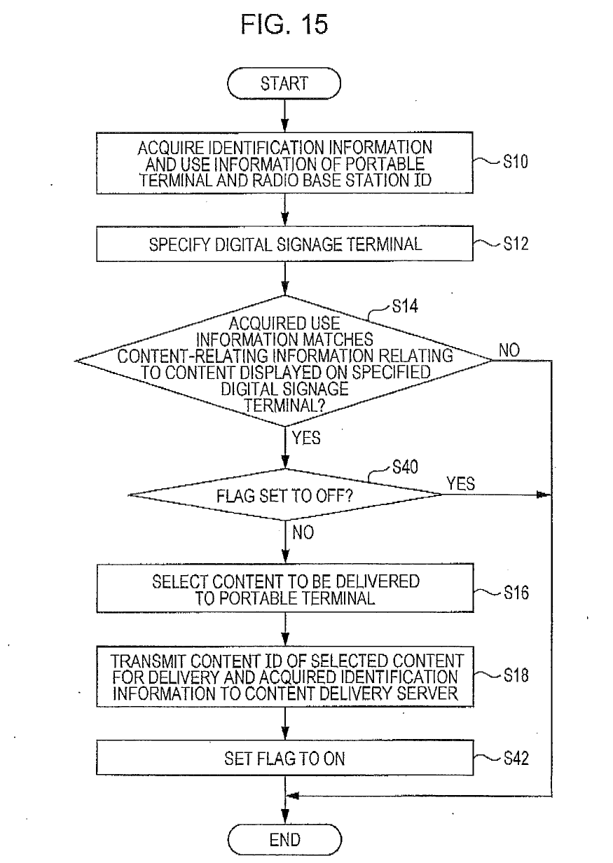

Next, regarding operations performed by the advertisement provision management server 3 according to the modification, operations relating to flag setting will be described with reference to FIG. 14. Then, operations performed by the advertisement provision management server 3 in relation to provision of an advertisement will be described with reference to FIG. 15. FIG. 14 is a flowchart illustrating operations (flag setting) performed by the advertisement provision management server 3 according to the modification.

Operations Relating to Flag Setting

First, in step S30 in FIG. 14, the content provision unit 313 determines whether or not a portable terminal has come into an area specified by the service provision area information 332e stored in the content-relating information database 332 in FIG. 12.

Specifically, the advertisement provision management server 3 determines that a portable terminal has come into an area specified by the service provision area information 332e when the advertisement provision management server 3 has received identification information of the portable terminal from a radio base station identified by the radio base station ID 332f.

In this case, the flow proceeds to step 932, the content provision unit 313 sets the flag 334a to 0 (off), the flag 334a corresponding to content (which is identifiable by the display content ID 334c) provided in an area specified by the service provision area information 332e, a portable terminal having been determined to have come into the area, and the processing ends.

For example, a description will be given of a case where the identification information 334b, which is “user A's user ID”, has been received from a radio base station identified by the radio base station ID 332f, which is “AP3845”. In this case, the content provision unit 313 supposes that a user A has come to “xx hall” indicated by the service provision area information 332e in order to receive a service relating to concert content identified by the display content ID 332a. Accordingly, the content provision unit 313 sets the flag 334a to 0 (off), the flag 334a corresponding to the identification information 334b that indicates “user A's user ID” and to the display content ID 334c indicating “concert content ID”, the identification information 334b and the display content ID 334c being stored in the flag management table 334.

Note that, if it is determined in step S30 in FIG. 14 that a portable terminal has not come into an area specified by the service provision area information 332e, the content provision unit 313 does not change setting of the flag 334a, and the processing ends.

Operations Relating to Provision of Advertisement

Next, operations relating to provision of an advertisement performed by the advertisement provision management server 3 according to the modification will be described with reference to FIG. 15. FIG. 15 is a flowchart illustrating operations (provision of an advertisement) performed by the advertisement provision management server 3 according to the modification.

In S10 in FIG. 15, the information acquisition unit 311 acquires identification information and use information of a portable terminal and the radio base station ID of a radio base station. Next, in step S12, the content selection unit 312 searches the signage information database 331 and selects the radio base station ID (access point ID) 331d that matches the radio base station ID that has been acquired. The content selection unit 312 thereafter selects the signage terminal ID 331a that is stored while being associated with the selected radio base station ID 331d. In this way, a digital signage terminal that is identified by the selected signage terminal ID 331a is specified.

Next, in step S14, the content selection unit 312 determines whether or not the use information that has been acquired matches the content-relating information 332b stored in the content-relating information database 332 (FIG. 12), the content-relating information 332b relating to content indicated by the display content ID 332a and being displayed on the specified digital signage terminal.

If it is determined in step S14 that the acquired use information does not match the content-relating information 332b, the advertisement provision management server 3 ends the processing. On the other hand, if it is determined in step S14 that the acquired use information matches the content-relating information 332b, the flow proceeds to step S40 and the content provision unit 313 determines whether or not the corresponding flag 334a stored in the flag management table 334 is set to 0 (off).

The flag 334a is set to 0 (off) in the case where a service relating to the delivered content has already been provided to the corresponding viewer. That is, the flag 334a being set to 0 (off) indicates that the portable terminal of the corresponding viewer is not a target of recapture. In this case, delivery of content to the portable terminal stops, and the processing ends without performing anything else. Note that, instead of stopping delivery of content to the portable terminal, content to be delivered to the portable terminal may be changed to information content intended for visiting customers and such information content may be delivered to the portable terminal.

On the other hand, if it is determined in step S40 that the flag 334a is not set to 0 (off), that is, if the flag 334a is set to 1 (on) or null (initial value), such a flag indicates that the portable terminal of the corresponding viewer is a target of recapture. Therefore, in this case, the content provision unit 313 performs processing in step S16 and step S18. That is, the content provision unit 313 selects content (S16) and transmits the content ID of the selected content and identification information of the portable terminal to the content delivery server 4 (S18). Then, in step S42, the content provision unit 313 sets the flag 334a to 1 (on) and the processing ends.

As described above, in the advertisement system 1 according to the modification, the storage unit 33 stores information on a location (area) to which a viewer carrying a portable terminal that has been recaptured is desired to be directed, as the service provision area information 332e of the content-relating information database 332, in response to a request made by an advertiser. Examples of a location to which a viewer carrying a portable terminal that has been recaptured is desired to be directed include a location of a shop of an advertiser. In this way, it is possible to determine whether or not a viewer carrying a portable terminal that was recaptured actually came to a location of a shop to which the advertiser desired to direct the viewer. On the basis of the result of such determination, a service provider that operates the advertisement provision management server 3 is able to perform billing for an occurrence of a viewer carrying a recaptured portable terminal actually coming to a location of a shop to which the advertiser desired to direct the viewer.

By setting the flag 334a to 0 (off) when a viewer carrying a recaptured portable terminal visited a location to which the advertiser desired to direct the viewer, it is possible to determine that the portable terminal is not a target of recapture any more. Accordingly, it is possible to stop delivery of selected content to the portable terminal that is not a target of recapture any more. As a result, the advertiser is able to reduce wasteful advertisement costs for a viewer carrying a portable terminal who actually visited a location of a shop to which the advertiser desired to direct the viewer.

Hardware Configuration

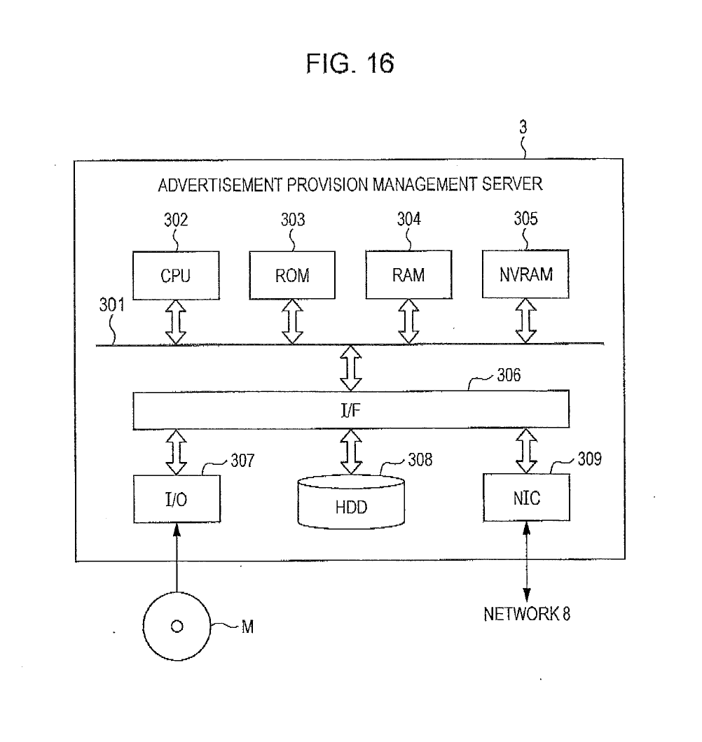

Lastly, an example of a hardware configuration of the advertisement provision management server 3 according to the embodiment and the modification will be described with reference to FIG. 16. FIG. 16 is a diagram illustrating an example of a hardware configuration of the advertisement provision management server 3.

In FIG. 16, the advertisement provision management server 3 includes a central processing unit (CPU) 302, a read-only memory (ROM) 303, a random access memory (RAM) 304, a non-volatile random access memory (NVRAM) 305, and an interface (I/F) 306 that are connected to a system bus 301. The advertisement provision management server 3 also includes an input/output (I/O) device 307, such as a keyboard, a mouse, a monitor, and a compact disk/digital versatile disk (CD/DVD) drive, a hard disk drive (HDD) 308, and a network interface card (NIC) 309 that are connected to the I/F 306. A reference character M represents a medium (recording medium), such as a CD/DVD, which stores a program or data.

The information acquisition unit 311, the content selection unit 312, and the content provision unit 313 in the control unit 31 may be implemented by processing performed in such a way that a program installed in the HDD 308 makes the CPU 302 perform the processing. The signage information database 331, the content-relating information database 332, the content management table 333, and the flag management table 334 may be implemented by using the RAM 304, the HDD 308, or a storage device not illustrated which is connected to the advertisement provision management server 3 over the network 8, for example.

The content delivery server 4 may also have the hardware configuration illustrated in FIG. 16. The digital signage terminal 5 may have a large-size video display in addition to the hardware configuration illustrated in FIG. 16.

While the advertisement provision management apparatus, the advertisement provision management method, and the program have been described with reference to an embodiment and a modification, the present invention is not limited to the embodiment or the modification described above, and various alternations and improvements may be made within the scope of the present invention.

For example, in the embodiment and the modification described above, a digital signage terminal installed at any location is taken as an example of a medium that displays content, and description has been given. This digital signage terminal is not necessarily installed outdoors or in a certain building and may be a display installed in a train, for example. The digital signage terminal may be a poster equipped with an NFC device. In this case, a portable terminal performs short-range communication with the NFC device to thereby implement the operations of the present invention.

What is claimed is:

1. An advertisement provision management apparatus comprising:
an information acquisition unit that acquires, from a portable terminal that is present in the vicinity of a digital signage terminal installed at any location, identification information of the portable terminal and use information of the portable terminal; and
a content selection unit that selects content to be displayed on the portable terminal identified by the identification information, on the basis of content-relating information stored while being associated with content displayed on the digital signage terminal and the use information acquired from the portable terminal.

2. The advertisement provision management apparatus according to claim 1, further comprising:
a content provision unit that controls provision of the selected content to the portable terminal identified by the identification information.

3. The advertisement provision management apparatus according to claim 2, wherein
the content provision unit
sets a flag to on when the selected content has been delivered to the portable terminal,
sets the flag to off when the portable terminal has been detected, the portable terminal having come into a service provision area, information on the service provision area having been stored while being associated with the provided content, and
makes delivery of the selected content to the portable terminal be in a stop state while the flag is set to off.

4. The advertisement provision management apparatus according to claim 1, further comprising:
a portable terminal identification unit that identifies a portable terminal that is present in the vicinity of the digital signage terminal, wherein
the portable terminal identification unit determines whether or not the portable terminal is present within an area that meets a predetermined condition based on a position of the digital signage terminal, on the basis of positional information stored in advance while being associated with the digital signage terminal and positional information on the portable terminal, and
the information acquisition unit acquires the identification information of the portable terminal that has been determined to be present within the area that meets the predetermined condition based on the position of the digital signage terminal, and the use information of the portable terminal.

5. The advertisement provision management apparatus according to claim 1, further comprising:
a portable terminal identification unit that identifies a portable terminal that is present in the vicinity of the digital signage terminal, wherein
the portable terminal identification unit determines whether or not the portable terminal is in a state where communication with a radio base station, identification information of the radio base station having been stored while being associated with the digital signage terminal, is possible, and
the information acquisition unit acquires the identification information of the portable terminal that has been determined to be in the state where communication with the radio base station is possible and the use information of the portable terminal.

6. An advertisement provision management method in which a computer executes a process, the process comprising:
acquiring, from a portable terminal that is present in the vicinity of a digital signage terminal installed at any location, identification information of the portable terminal and use information of the portable terminal; and
selecting content to be displayed on the portable terminal identified by the identification information, on the basis of content-relating information stored while being associated with content displayed on the digital signage terminal and the use information acquired from the portable terminal.

7. A recording medium storing a program that makes a computer execute a process, the process comprising:
acquiring, from a portable terminal that is present in the vicinity of a digital signage terminal installed at any location, identification information of the portable terminal and use information of the portable terminal; and
selecting content to be displayed on the portable terminal identified by the identification information, on the basis of content-relating information stored while being associated with content displayed on the digital signage terminal and the use information acquired from the portable terminal.
